(19) United States
(12) Patent Application Publication
(10) Pub. No.: US 2025/0029770 A1
(43) Pub. Date: Jan. 23, 2025

(54) INDUCTOR AND TRANS-INDUCTOR VOLTAGE REGULATOR

(71) Applicants: HUIZHOU POCO NEW INDUCTOR TECHNOLOGY CO., LTD., Huizhou City (CN); SHENZHEN POCO MAGNETIC CO., LTD., Shenzhen City (CN); HUIZHOU POCO INDUSTRY CO., LTD., Huizhou City (CN); HEYUAN POCO MAGNETIC CO., LTD., Heyuan City (CN)

(72) Inventors: TAO LUO, Shenzhen City (CN); XIONGZHI GUO, Shenzhen City (CN); YUNFAN ZHANG, Shenzhen City (CN)

(21) Appl. No.: 18/772,257

(22) Filed: Jul. 14, 2024

(30) Foreign Application Priority Data
Jul. 17, 2023 (CN) 202310877670.0

(51) Int. Cl. H01F 27/28; H01F 27/24; H01F 41/04

(52) U.S. Cl. CPC H01F 27/28; H01F 27/24; H01F 41/04

(57) ABSTRACT

An inductor provided in the present invention, includes a magnetic core and one or more conductive coil assembly embedded in the magnetic core; each conductive coil assembly comprises an inner conductive coil and an outer conductive coil coupled to the inner conductive coil. The inner conductive coil and the outer conductive coil are insulated from each other; the inner conductive coil rans through the outer conductive coil whereby most of or all magnetic field lines of the inner conductive coil pass through the outer conductive coil. A trans-inductor voltage regulator provided, includes a circuit board and the inductor electrically connected to the circuit board. The inductor has a coupling coefficient more than 98%.

### CROSS REFERENCE TO RELATED APPLICATIONS

The present invention is 35 U.S.C. § 119 benefit of earlier filing dates; rights of priority of Chinese Applications No. 202310877670.0 filed on Jul. 17, 2023, the disclosure of which is incorporated by reference herein.

### BACKGROUND OF THE INVENTION

### Field of the Invention

The present invention relates to the field of electronic components, and more particularly, to an inductor.

### Description of Related Art

At present, most traditional coupled inductors are assembled structures, and the materials of the magnetic core generally are ferrite. The magnetic core, conductive coils and coupling are assembled together to obtain the coupled inductor. The assembled inductor is not suitable for trans-inductor voltage regulator (TLVR), and there is a problem of low inductive coupling. The magnetic core and conductive coils cannot be in full contact in the assembled inductor, the power density is low, and the heat dissipation is insufficient.

### SUMMARY OF THE INVENTION

An object of the present invention is to is to provide an inductor to solve the problems of low inductive coupling of existing inductors.

An inductor provided by the present invention, comprises a magnetic core, and one or more conductive coil assembly embedded in the magnetic core. Each conductive coil assembly comprises an inner conductive coil and an outer conductive coil coupled to the inner conductive coil. The inner conductive coil and the outer conductive coil are insulated from each other; the inner conductive coil rans through the outer conductive coil whereby most of or all magnetic field lines of the inner conductive coil pass through the outer conductive coil.

Preferably, the inductor is an integrated inductor manufactured by an integrated molding process; the conductive coil assembly is inseparably embedded in the magnetic core.

In some embodiments, a straight channel is formed inside the outer conductive coil and extends to opposite sides of the outer conductive coil and extends to opposite end surfaces of the magnetic core; the outer conductive coil has a main body and opposite leads at opposite sides thereof, the opposite leads extend to said opposite end surfaces of the magnetic core respectively; the inner conductive coil is straight, has a main body and opposite leads at opposite ends thereof, and is inserted in the straight channel in the outer conductive coil, and the opposite leads of the inner conductive coil extend to and said opposite end surfaces of the magnetic core.

In some embodiments, the main body of the outer conductive coil is straight, the straight channel is provided in the straight main body along a length thereof; the inner conductive coil inserted in the straight channel of the outer conductive coil, has the opposite leads thereof passing through the opposite leads of the outer conductive coil and extending to opposite end surfaces of the magnetic core respectively; and the inner conductive coil is parallel to the straight main body of the outer conductive coil. The outer conductive coil is U-shaped or Z-shaped or straight as a whole.

In some embodiments, the opposite leads of the U-shaped outer conductive coil are bent respectively from opposite sides of the main body, extend to opposite end surfaces of the magnetic core, and are exposed on said opposite end surfaces and/or exposed on the same adjacent end surface of said opposite end surface of the magnetic core; and the end surfaces of the magnetic core with the leads thereon is kept flat or planar. The opposite leads of the Z-shaped outer conductive coil are bent respectively from opposite sides of the main body, extend to said opposite end surfaces of the magnetic core, and are exposed on said opposite end surfaces and/or exposed on respective adjacent surfaces of said opposite end surfaces of the magnetic core; and the end surfaces of the magnetic core with the leads thereon is kept flat or planar.

In some embodiments, the inner conductive coil is covered with an insulating layer and/or an inner wall of the straight channel is covered with an insulating layer; the inner conductive coil and the outer conductive coil are insulated from each other by the insulating layer, and the insulating layer provides a spacing between the inner conductive coil and the inner wall of the straight channel close enough whereby a coupling coefficient between the inner conductive coil and the outer conductive coil reaches 0.98 or above.

In some embodiments, insulating magnetic powder is filled between the inner conductive coil and an inner wall of the straight channel to form an insulating layer therebetween which provides electrical insulation and a sufficiently close distance between the inner conductive coil and the outer conductive coil, whereby a coupling coefficient between the inner conductive coil and the outer conductive coil reaches 0.98 or above.

In some embodiments, the magnetic core and the conductive coil assembly are integrated by means of an integrated molding process using magnetic powder filing around the conductive coil assembly in one mold, whereby the magnetic core and the conductive coils are fully contacted and tightly combined; the integrated molding process comprising steps of: a pressing and molding step; and an annealing step.

In some embodiments, the inductor is a multi-phase coupling inductor and comprises multiple conductive coil assemblies embedded in the magnetic core, and each conductive coil assembly includes the inner conductive coil and the outer conductive coil that are coupled to each other.

In some embodiments, each conductive coil assembly is arranged in parallel and spaced apart from each other, and the inner conductive coil and the outer conductive coil are parallel to each other; the inner conductive coils of each conductive coil assembly are electrically connected in series, and the outer conductive coils and corresponding inner conductive coils of each conductive coil assembly are coupled to each other, thereby a high dynamic response is obtained.

In some embodiments, for one multiple conductive coil assembly, which is located at one side of the magnetic core, the outer conductive coil defines an open straight groove along a length thereof, and the inner conductive coil is inserted in the open straight groove; the open straight groove extends to opposite sides of the outer conductive coil and extends to opposite end surfaces of the magnetic core.

In some embodiments, for other multiple conductive coil assemblies, the outer conductive coil defines a straight channel therein along a length thereof, the straight channel extends to opposite sides of the outer conductive coil and extends to said opposite end surfaces of the magnetic core; the outer conductive coil has a straight main body and opposite leads at opposite sides thereof, the opposite leads extend to said opposite end surfaces of the magnetic core respectively; the inner conductive coil is a straight, has a main body and opposite leads at opposite ends thereof, and is inserted in the straight channel in the outer conductive coil, and the opposite leads of the inner conductive coil pass through the opposite leads of the outer conductive coil and extend to said opposite end surfaces of the magnetic core, respectively.

The present invention provides a trans-inductor voltage regulator, comprising a circuit board, and the inductor of any of above-described embodiments which is electrically connected to the circuit board.

The advantages of the present invention are:
the inductor of the present invention adopts an inner conductive coil is inserted through an outer conductive coil, the inner and outer conductive coils are embedded in the magnetic core by means of integrated molding, thereby, a very high coupling coefficient is obtained. The coupling coefficient can be more than 0.98, that's almost a full coupling, thus a fast response of the inductor is obtained and the powder loss is reduced.

In some embodiments, the inductor of the present invention, the magnetic core and the conductive coils are integrated into inseparable one piece, magnetic powder fully fill gaps in the magnetic core and between the conductive coils, which improves the magnetic permeability and magnetic flux density of the inductor, and reduces the powder loss. The magnetic core and conductive coils are tightly combined, and have good heat conduction and heat dissipation effects, which can keep the inductor at a lower operating temperature. The magnetic core and conductive coils are molded in one piece to give the inductor a high density.

### BRIEF DESCRIPTION OF DRAWINGS

FIG. 1 illustrates a perspective view of an integrated inductor in accordance with a first embodiment of the present invention;

FIGS. 2-3 illustrate cross-sectional views of the integrated inductor in accordance with the first embodiment of the present invention;

FIG. 4 illustrates a perspective view of the integrated inductor in accordance with a second embodiment of the present invention;

FIGS. 5-6 illustrate cross-sectional views of the integrated inductor in accordance with the second embodiment of the present invention;

FIG. 7 illustrates a perspective view of the integrated inductor in accordance with a third embodiment of the present invention;

FIGS. 8-9 illustrate cross-sectional views of the integrated inductor in accordance with the third embodiment of the present invention;

FIG. 10 illustrates a perspective view of the integrated inductor in accordance with a fourth embodiment of the present invention;

FIG. 11 illustrates a perspective view of an internal structure of the integrated inductor in accordance with the fourth embodiment of the present invention;

FIGS. 12-13 illustrate cross-sectional views of the integrated inductor in accordance with the fourth embodiment of the present invention;

FIG. 14 illustrates a perspective view of the integrated inductor in accordance with a fifth embodiment of the present invention;

FIG. 15 illustrates a perspective view of an internal structure of the integrated inductor in accordance with the fifth embodiment of the present invention; and

FIGS. 16-17 illustrate cross-sectional views of the integrated inductor in accordance with the fifth embodiment of the present invention.

### DETAILED DESCRIPTION OF THE INVENTION

An integrated inductor is described herein. Exemplary embodiments of the present invention will be described in more detail below with reference to the accompanying drawings. Although exemplary embodiments of the present invention are shown in the drawings, the present invention may be implemented in various forms and should not be limited to the embodiments described below. Rather, these embodiments are provided to enable those skilled in the art to completely understand the present invention.

Certain terminology is used in the following description for convenience only and is not limiting. The words “a”, “an” and “one”, as used in the claims and in the corresponding portions of the specification, are defined as including one or more of the referenced items unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof. It may be noted that some Figures are shown with partial transparency for the purpose of explanation, illustration and demonstration purposes only, and is not intended to indicate that an element itself would be transparent in its final manufactured form.

Although the terms first, second, etc. may be used herein to describe various elements, components, regions, layers and/or sections; these elements, components, regions, layers and/or sections shall not be referred to as limited by these terms. These terms are only used to distinguish one element, component, region, layer or section from another element, component, region, layer or section. Terms such as “first,” “second,” and other numerical terms when used herein do not imply a sequence or order unless clearly indicated by the context. Thus, an element, component, region, layer or section discussed below could be termed a second element, component, region, layer or section without departing from the teachings of the example embodiments.

For ease of description, orientational terms may be used herein to describe the relationship of one element or feature to another element or feature as shown in the figures, such as “internal”, “external”, “inside”, “outside”, “below”, “beneath”, “under”, “above”, “on”, “top”, “bottom”, “front”, “rear”, “left”, “right”, etc. Such orientational terms are intended to encompass different orientations of the device in use or operation in addition to the orientation depicted in the figures and description. For example, if the device in the figures is turned over, elements described as “below” or “beneath” or “under” other elements or features would then be oriented “above” or “on” the other elements or features. Thus, the example term “below” may include an orientation of above and below. The device may be otherwise oriented (rotated 90 degrees or at other orientations) and the orientation herein should be interpreted accordingly.

The experimental methods described in the following examples, if no special limitations are given, are conventional methods; the reagents and materials, if no special limitations are given, can be obtained from commercial sources.

Numerical values or value ranges disclosed herein are not limited to the precise values or range, but should be understood to include values approaching these ranges or values. For numerical ranges, the endpoints and any point values within the range, individual or combined with each other to obtain one or more new value ranges, shall be deemed to be specifically disclosed herein.

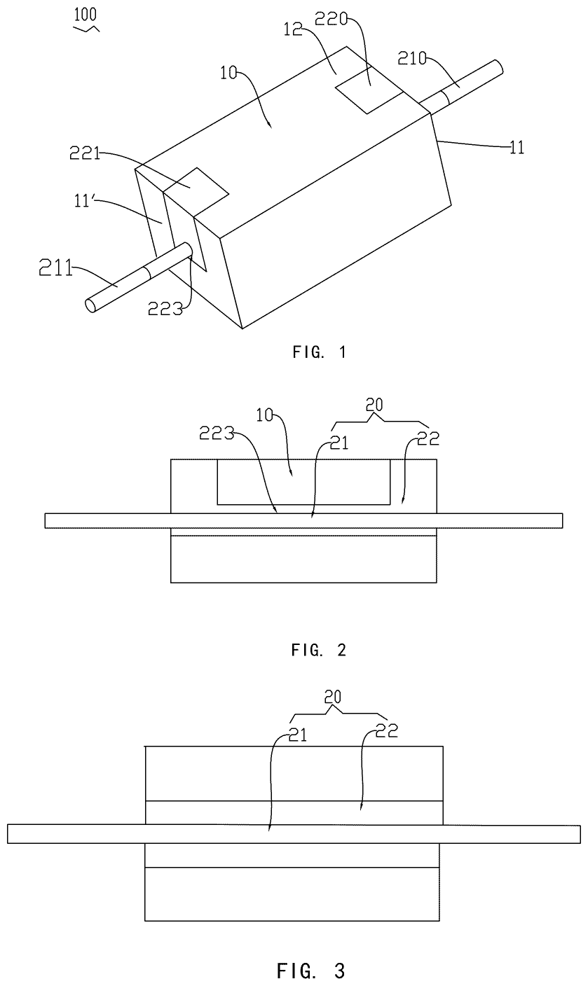

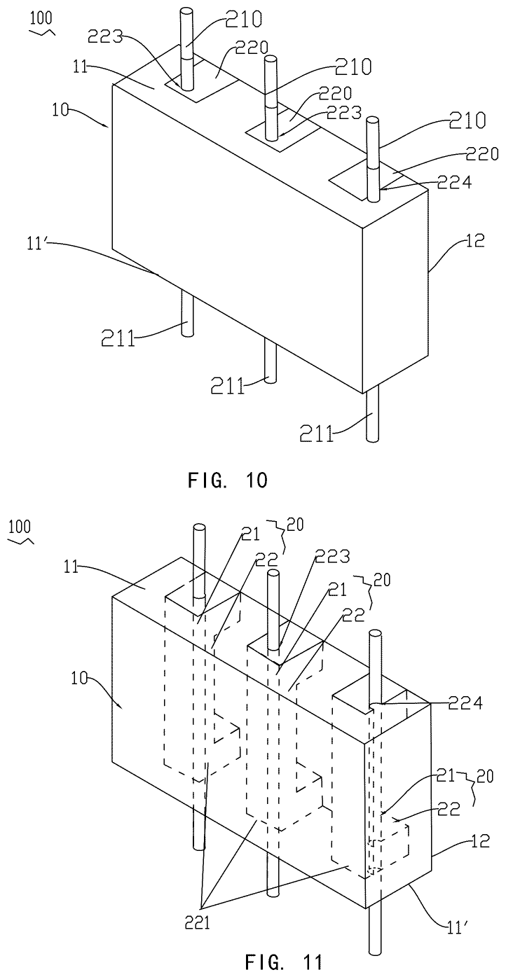

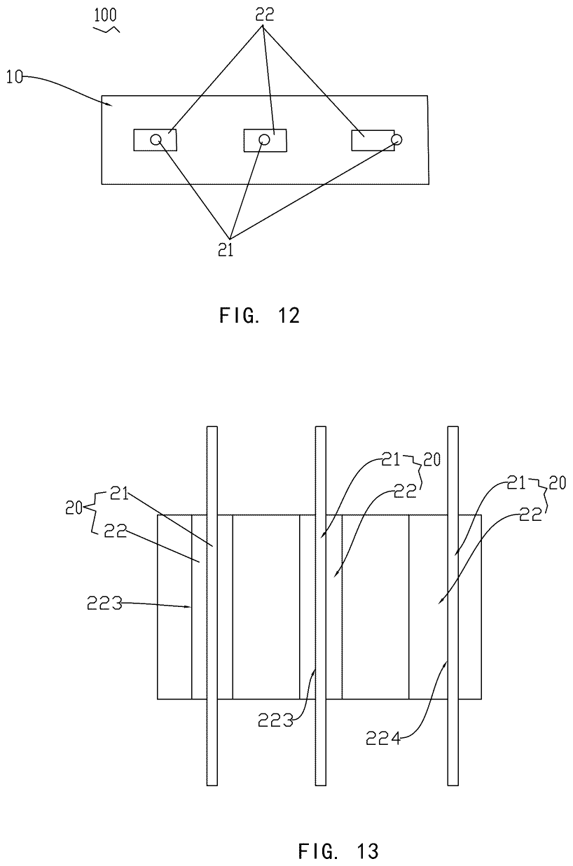

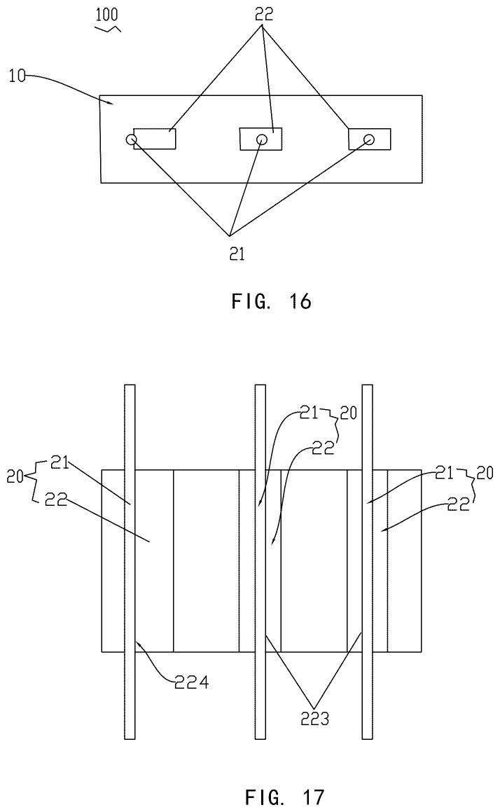

Referring to FIGS. 1-17, an integrated inductor 100 of the present invention includes a magnetic core 10 and one or more coupled conductive coil assembly 20 embedded inside the magnetic core 10. The integrated inductor 100 can be single-phase coupled or multi-phase coupled, where the single-phase inductor has one or more pair of conductive coils in the magnetic core 10, and the multi-phase inductor has multiple pair of conductive coils in the magnetic core 10. Each conductive coil assembly 20 includes an inner conductive coil 21 and an outer conductive coil 22 which are coupled to each other. The inner conductive coil 21 is longitudinally inserted in and rans through the outer conductive coil 22. The inner conductive coil 21 comprises a main body and opposite leads 210, 211 at opposite ends of the coil 21 (or at opposite ends of the main body), and the outer conductive coil 22 comprises a main body and opposite leads 220, 221 at opposite sides of the coil 22 (or at opposite sides of main body), the main body of the inner conductive coil 21 is encapsuled inside the main body of the outer conductive coil 22. Surfaces of the inner conductive coils 21 and/or the outer conductive coils 22 are covered with a thin insulating layer, or a spacing between the conductive coils 21 and 22 is filled with insulating magnetic powder (particles), thus the inner conductive coil 21 is electrically insulated from the outer conductive coil 22. The inner conductive coil 21 is entirely inside the outer conductive coil 22 along a length direction, almost all magnetic lines of the inner conductive coil 21 pass through the outer conductive coil 22, therefore, a coupling coefficient between the coils 21 and 22 makes the inductor 100 work as an omni (full) coupled inductor, that is, the coupling coefficient is close to 1. A distance between the two conductive coils 21 and 22 is close enough to obtain such high coupling coefficient to an omni coupling. The coupling coefficient can be 0.98 or above, and close to 1, and a fast response can be obtained. Since a distance between the inner conductive coil 21 and the outer conductive coil 22 is close enough, further, the inner conductive coil 21 is encapsuled/inserted inside the outer conductive coil 22, therefore, almost all magnetic field lines of the inner conductive coil 21 passes through the outer conductive coil 22, which results a high coupling coefficient.

In some specific embodiments, a straight channel 223 is formed in the outer conductive coil 22, ran through a length of the coil 22, and extend to opposite end surfaces 11, 11′ of the magnetic core 10. The leads 220, 221 at opposite sides of the outer conductive coil 22 are exposed on end surface(s) of the magnetic core 10 for facilitating electrical connection with a circuit on a circuit board. Generally, the end surface(s) of the magnetic core with leads 220, 221 thereon keeps flat or planar. The inner conductive coil 21 is straight-out or straight, and is inserted in and ran through the straight channel 223 in the outer conductive coil. The opposite leads 210 and 211 at opposite ends of the inner conductive coil 21 extend to and are exposed on opposite end surfaces 11 and 11′ of the magnetic core 10 for facilitating electrical connection with the circuit on the circuit board.

The outer conductive coil 22 includes a linear main body, and the straight channel 223 rans though the linear main body along a length direction thereof. The inner conductive coil 21 is inserted in the straight channel 223 and is parallel to the linear main body of the outer conductive coil 22. The inner conductive coil 21 passes through the straight channel 223 in the outer conductive coil 22, and the straight leads 210 and 211 of the coil 21 respectively pass through the leads 220 and 221 of the outer conductive coil 22 and extend out of opposite end surfaces 11 and 11′ of the magnetic core 10.

Surfaces of the conductive coil 21, 22 or a spacing between the conductive coils is covered with a thin insulating layer, or is insulated by insulating magnetic particles. Specifically, the surface of the inner conductive coil 21 is covered with a thin insulating layer, and/or an inner wall of the straight channel 223 of the outer conductive coil 22 is covered with a thin insulating layer thereon. The thin insulating layer insulates and separates the inner conductive coil 21 from the inner wall of the straight channel 223 in the outer conductive coil 22, thus a distance between the inner conductive coil 21 and the inner wall of the straight channel 223 is close enough and the coupling coefficient between the inner and outer conductive coils 21 and 22 reaches more than 0.98. In other embodiments, the thin insulating layer may be formed by insulating soft magnetic powder (particles), so that the distance between the inner conductive coil 21 and the inner wall of the straight channel 223 is close enough.

In some embodiments, the integrated inductor 100 is a multi-phase coupling inductor, and multiple coupled conductive coil assemblies 20 are embedded in the magnetic core 10. Each conductive coil assembly 20 includes the inner and outer conductive coils 21, 22 that are coupled to each other; The conductive coil assemblies 20 are arranged parallel and spaced apart from each other, and the inner and outer conductive coils 21, 22 are parallel to each other. The inner conductive coils 21 are electrically connected in series with each other, and the outer conductive coil 22 of each conductive coil assembly 20 is coupled to the corresponding inner conductive coil 21 therein, thereby a highly dynamic response is obtained.

In some embodiments, in the multi-phase coupled inductor 100, for a higher coupling between conductive coil assemblies 20 and eliminating interference, one outermost conductive coil assembly 20 is configured that:

an open straight groove 224 is formed on a surface of the outer conductive coil 22 along a length thereof, and extend to opposite ends of the outer conductive coil 22 and opposite end surfaces 11, 11′ of the magnetic core 10, the leads 220 and 221 at opposite sides of the outer conductive coil 22 are exposed on opposite end surface 11, 11′ of the magnetic core 10;

the inner conductive coil 21 is inserted and rans through the open straight groove 224 of the outer conductive coil 22, and the leads 210 and 211 of the coil 21 respectively pass through the leads 220 and 221 of the outer conductive coil 22 and extend out of opposite end surfaces 11 and 11′ of the magnetic core; and
there is a sufficiently close distance or spacing between the inner conductive coil 21 and the outer conductive coil 22. In some embodiments, a thin insulating layer covering on an inner wall of the straight groove 224 and/or on the outer surface of the inner conductive coil 21 to obtain an enough close distance and electrically insulation between the coils 21 and 22 when the inner conductive coil 21 is inserted in the outer conductive coil 22. In other embodiments, fill soft magnetic powder between the coils 21 and 22 to form a thin insulating layer, thus obtain an enough close distance and electrically insulation therebetween, thereby a high coupling between the inner and outer conductive coil 21 and 22 is obtained.

In a preferred embodiment, the outer conductive coil 22, comprising the main body and opposite leads 220 and 221 on opposite sides of the main body, is “U”-shaped or “Z”-shaped or straight-out (straight). The pair of leads 220 and 221 of the outer conductive coil 22 are bent from opposite sides of the main body and exposed on the end surfaces of the magnetic core 10 respectively, and the end surfaces with the leads 220, 221 thereon of the magnetic core 10 is kept flat or planar. The inner conductive coil 21 is a straight (such as a straight rod). The inner conductive coil 21 is completely inserted into or completely placed in the outer conductive coil 22. Opposite straight leads 210 and 211 extend out of opposite surfaces, that is, the first end surfaces 11/11′ of the magnetic core 10.

In some embodiments, a cross-sectional shape of the inner and outer conductive coils 21, 22 may be: square, rectangle, circle, ellipse, triangle, etc.

In one exemplary embodiment, the magnetic core 10 and the conductive coil assembly 20 can be formed into an integrated structure by means of a molding process by filling magnetic powder around the conductive coil assembly 20 in a mold. The molding process comprises the following steps:
pressing and molding step, specifically: installing conductive coil assembly(s) 20 in a mold with the inner conductive coil 21 inserted into the outer conductive coil 22, filling the mold cavity with magnetic powder, applying pressure for molding, where the molding pressure can be 12˜24 T/cm2, then obtaining a raw inductor of which the conductive coils are embedded in the magnetic core and the leads are exposed on the surface(s) of the magnetic core; and
annealing step: placing the raw inductor in a heat treatment furnace for calcinating and annealing so as to release residual stress inside the magnetic core, and obtaining the integrated inductor with a high dynamic response, where annealing temperature can be 400˜850° C.

Magnetic powder is insulating magnetic powder (particles), and the insulating magnetic powder can be one or more of Fe-based powder, Fe—Si powder, Fe—Si—Al alloy powder, Fe—Ni alloy powder, etc., or amorphous powder thereof.

During the molding process, soft magnetic powder is filled around conductive coils in the mold, soft magnetic powder material is evenly distributed between the conductive coils and make the conductive coils electrically insulated from each other. The magnetic core and conductive coils fully contact to obtain a rapid heat transfer. The molding process at a high-pressure (12˜24 T/cm2) significantly reduces gaps inside the inductor (or inside magnetic core), through which an inductor can be obtained with full space utilization and at a high-power density. A multi-phase integrated inductor with a high dynamic response can be manufactured by means of molding soft magnetic powder filled around multiple conductive coils in one mold, which can save a volume of the inductor. The inductor of the present invention has a small profile and high-power density.

Referring to FIGS. 1-3, the integrated inductor 100 in accordance with a first embodiment includes a square (not limited to square) magnetic core 10 and a conductive coil assembly 20 embedded in the magnetic core 10. The conductive coil assembly 20 includes an inner conductive coil 21 and an outer conductive coil 22. The inner conductive coil 21 is straight-out (straight), is completely built-in the outer conductive coil 22, rans through the outer conductive coil 22, and is parallel to the outer conductive coil 22 along a length direction thereof. Opposite leads 210, 211 of the inner conductive coil 21 extend outwards from opposite leads 220, 221 of the outer conductive coil 22 respectively and are exposed on opposite end surfaces 11, 11′ of the magnetic core 10. The straight channel 223 is define in the outer conductive coil 22 and along a length direction thereof. The inner conductive coil 21 is inserted in the straight channel 223. Through an integrated molding process using magnetic powder and the conductive coils 21, 22, the insulating magnetic powder material is evenly distributed between the conductive coils, thus the conductive coils 21 and 22 are sufficiently close together and electrically insulated from each other, there is almost no gap inside the inductor (or in the magnetic core), thereby the inner and outer conductive coils 21 and 22 represent a very high coupling coefficient such as 0.98 or above, near a complete coupling. Alternatively, the inner conductive coil 21 is covered with an insulating layer, is inserted into the straight channel 223, and is electrically insulated from the outer conductive coil 22. The outer conductive coil 22, comprising a main body and opposite leads 220 and 221 at opposite sides thereof, is U-shaped as a whole. The main body of the outer conductive coil 22 is linear, specifically is straight. The lead 220 is bent to and exposed on two adjacent end surfaces 11 and 12 of the magnetic core 10. The other lead 221 is bent to and exposed on the two adjacent end surfaces 11′ and 12 of the magnetic core 10, and the end surfaces 11 and 11′ are opposite to each other. The leads 220 and 221 are embedded in the end surface for keeping the end surfaces flat or planar. A conductive coating may be formed on the end surfaces for electrically connected with the leads 220 and 221 respectively for facilitating electrically connected with the circuit of the circuit board.

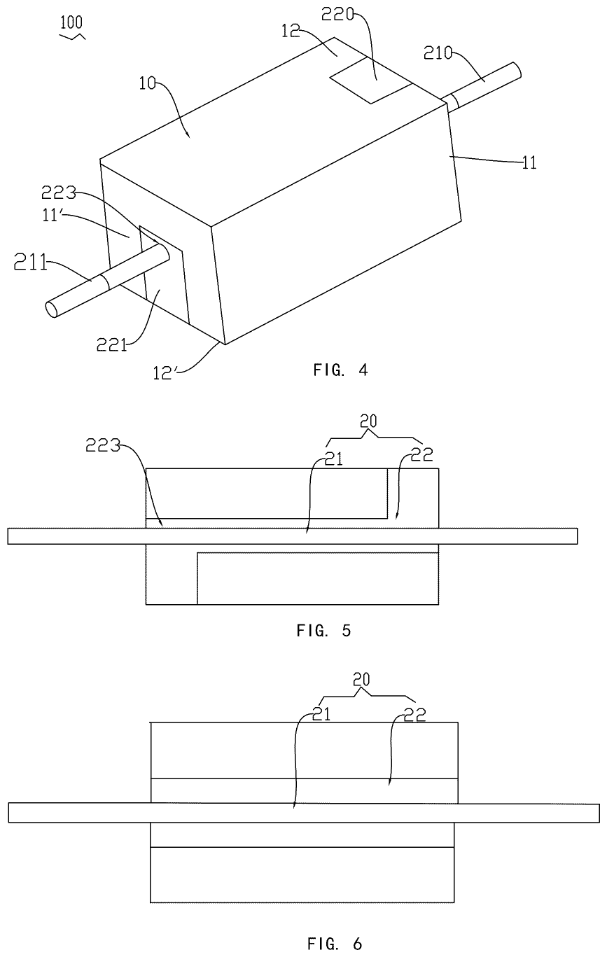

Referring to FIGS. 4-6, the integrated inductor 100 in accordance with a second embodiment, includes the square (not limited to square) magnetic core 10 and the conductive coil assembly 20 embedded in the magnetic core 10. The conductive coil assembly 20 includes a pair of inner and outer conductive coils 21 and 22. The inner conductive coil 21 is a straight out or straight conductive coil, completely built in the outer conductive coil 22, and parallelly inserted into the linear main body of the outer conductive coil. The opposite leads 210, 211 of the inner conductive coil 21 respectively extend outwards from the opposite leads 220, 221 of the outer conductive coil 22 and are exposed on opposite end surfaces 11, 11′ of the magnetic core 10. The outer conductive coil 22 inside forms the straight channel 223, and the straight inner conductive coil 21 is inserted into the straight channel 223. The gap between the inner conductive coil and the inner wall of the straight channel 223 is filled with magnetic powder to form a thin insulating layer. The conductive coils 21 and 22 and the magnetic core 10 are integrated by means the integrated molding process. Insulating magnetic powder material is evenly distributed between the conductive coils, so that the conductive coils 21 and 22 form the closest distance therebetween and are electrically insulated from each other. There is almost no gap inside the inductor, a complete/full coupling is obtained between the inner and outer conductive coils 21 and 22, and the coupling coefficient exceeds 0.98. Alternatively, the surface of the inner conductive coil 21 is covered with an insulating layer, is inserted in the straight channel 223, and is electrically insulated from the outer conductive coil 22. The outer conductive coil 22, comprising a main body and opposite leads 220 and 221 at opposite sides thereof, is Z-shaped as a whole. The main body of the outer conductive coil 22 is linear, specifically is straight. The lead 220 is bent from the main body and exposed on the two adjacent end surfaces 11 and 12 of the magnetic core 10. The other lead 221 is bent from the main body and is exposed on the two adjacent end surfaces 11′ and 12′ of the magnetic core 10. The end surfaces 11 and 11′ are opposite to each other, and the end surfaces 12 and 12′ are opposite to each other. The leads 220 and 221 are embedded in the end surfaces and keep the end surfaces flat or planar. The leads 220 and 221 can be electrically connected and expanded by covering a conductive coating on the end surfaces of the magnetic core 10.

In other embodiments, the outer conductive coil 22 can be a straight-out or straight conductive coil, embedded in the magnetic core 10, ran through the magnetic core and expend outwards from opposite end surfaces 11/11′ of the magnetic core 10. The opposite leads 220, 221 are exposed on or extend out of opposite end surfaces 11/11′ of the magnetic core 10. The straight channel 223 rans through inside the straight outer conductive coil 22 along a length thereof, and the inner conductive coil 21 is inserted into the straight channel 223 with the opposite leads 210 and 211 extending out of opposite end surfaces 11/11′ of the magnetic core 10.

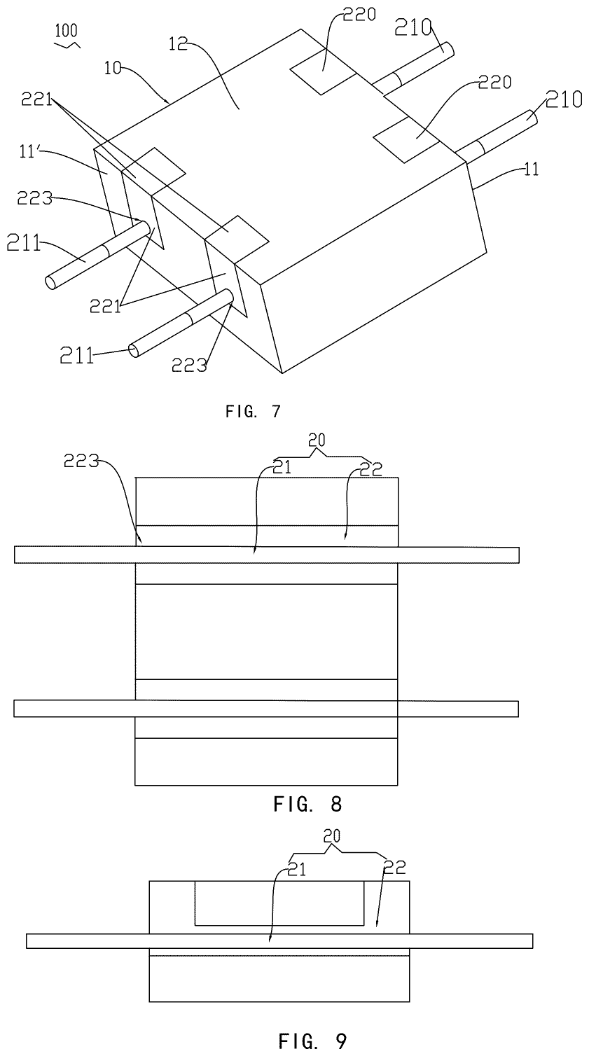

Referring to FIGS. 7-9, the integrated inductor 100 in accordance with a third embodiment includes the square (not limited to square) magnetic core 10 and multiple conductive coil assemblies 20 embedded in the core 10 to form a multi-phase coupling integration. As shown in the figure, two conductive coil assemblies 20 are arranged in parallel and spaced apart in the magnetic core 10, and the inner and outer conductive coils 21 and 22 are parallel to each other. Each conductive coil assembly 20 includes a pair of inner and outer conductive coils 21 and 22. The inner conductive coil 21 is a straight-out or straight conductive coil, completely built in the outer conductive coil 22, and is inserted into the outer conductive coil in parallel along the length direction. The opposite leads 211, 210 extend outwards from the outer conductive coil to the opposite surfaces 11, 11′ of the magnetic core 10. A straight channel 223 is formed in the outer conductive coil 22, runs through the coil 22 and extends to opposite end surfaces 11, 11′ of the magnetic core 10 along the length direction. The straight inner conductive coil 21 is inserted into the straight channel 223. The gap between the inner wall of the straight channel 223 and the straight inner conductive coil 21 is filled with insulating magnetic powder to form a thin insulating layer. Insulating magnetic powder and the conductive coils 21 and 22 are integrated by means of an integrated molding process. The insulating magnetic powder material is evenly distributed between the conductive coils, so that the conductive coils 21 and 22 are spaced as a closest distance and electrically insulated from each other. There is almost no gap inside the inductor, so that almost a full coupling is formed between the inner and outer conductive coils 21 and 22, and the coupling coefficient exceeds 0.98. Alternatively, the surface of the inner conductive coil 21 is covered with a thin insulating layer, is inserted into the straight channel 223, and is electrically insulated from the outer conductive coil 22. The outer conductive coil 22, comprises a main body and opposite leads 220 and 221 at opposite sides thereof, is a C-shaped or U-shaped as a whole. The main body of the outer conductive coil 22 is linear, with a straight channel 223 formed inside; the lead 220 is bent from the main body and embedded in the two adjacent end surfaces 11 and 12 of the magnetic core 10. The other lead 221 is bent from the main body and embedded in two adjacent end surfaces 11′ and 12 of the magnetic core 10. The end surfaces 11 and 11′ are opposite to each other. The leads 220 and 221 are embedded in the end surfaces and are exposed on the end surfaces to keep the end surfaces flat or planar. The leads 220 and 221 may also be electrically connected and covered respectively by a conductive coating covered on the end surfaces of the magnetic core 10 for facilitating electrical connection to the circuit board.

Referring to FIGS. 10-13, the integrated inductor 100 in accordance with a fourth embodiment includes the square (not limited to square) magnetic core 10 and multiple conductive coil assemblies 20 embedded in the magnetic core 10 to form a multi-phase coupling integration. As shown in the figures, three conductive coil assemblies 20 are arranged in parallel and spaced apart in the magnetic core 10, and the inner and outer conductive coils 21 and 22 are parallel to each other. Each conductive coil assembly 20 includes a pair of inner and outer conductive coils 21 and 22. The outer conductive coil 22, comprises a main body and opposite leads 220 and 221, is U-shaped as a whole. The main body of the outer conductive coil 22 is linear or straight. The two adjacent outer conductive coils 22, namely one outermost and middle coils 22, respectively form a straight channel 223 inside along a length thereof; while the other conductive coil 22, that is the other outermost coil 22, forms an open straight groove 224 on its surface away from the other coils 22 along a length thereof; and the straight channel 223 and the open straight groove 224 extend to opposite end surfaces 11, 11′ of the magnetic core 10. For each conductive coil assembly 20, the lead 220 is bent from the main body of the outer conductive coil 22 and embedded in two adjacent end surfaces 11 and 12 of the magnetic core, while the other lead 221 is bent from the main body and embedded in the two adjacent end surfaces 11′ and 12 of the magnetic core 10. The end surfaces 11 and 11′ are opposite to each other. The leads 220 and 221 are embedded in the end surfaces, exposed on the end surfaces and keep the end surfaces flat or planar. The leads 220 and 221 may be electrically connected with and covered by a conductive coating on the end surfaces, respectively. The inner conductive coil 21 is a straight-out conductive coil, and is inserted parallelly along the length direction into the straight channel 223 defined in the outer conductive coil 22 or is inserted into the open straight groove 224 formed on the surface of the outer conductive coil 22. The opposite straight leads 211, 210 of the inner conductive coil 21 respectively extend outwards from the leads 220, 221 of the outer conductive coil 22 and extend outwards from the opposite surfaces 11, 11′ of the magnetic core 10. The straight inner conductive coil 21 is inserted into the straight channel 223 inside the outer conductive coil 22 or inserted into the open straight groove 224 on the surface of the outer conductive coil 22. The gap between the inner conductive coil and the inner wall of the straight channel 223/open straight groove 224 is filled with magnetic powder to form a thin insulating layer. The magnetic powder and the conductive coils 21 and 22 are integrated together. The insulating magnetic powder material is evenly distributed between the conductive coils, so that the conductive coils 21 and 22 is spaced at the closest distance and electrically insulated from each other. There is almost no air gap inside the inductor or the magnetic core. The inner and outer conductive coils 21 and 22 are completed coupled to each other, and the coupling coefficient exceeds 0.98. Alternatively, the surface of the inner conductive coil 21 is covered with an insulating layer, is inserted into the straight channel 223 and insulated from the outer conductive coil 22.

This embodiment takes three-phase coupling as an example to illustrate the principle of multi-phase coupling. The first, second, and third (or more) inner conductive coils can be electrically connected in series, the first outer conductive coil is coupled to the first inner conductive coil, and the coupling signal (current and voltage) formed in the first inner conductive coil must flow through the second and third inner conductive coils. Moreover, the second inner and outer conductive coils are fully coupled to each other, and the third inner and outer conductive coils are fully coupled, thus a high response is obtained.

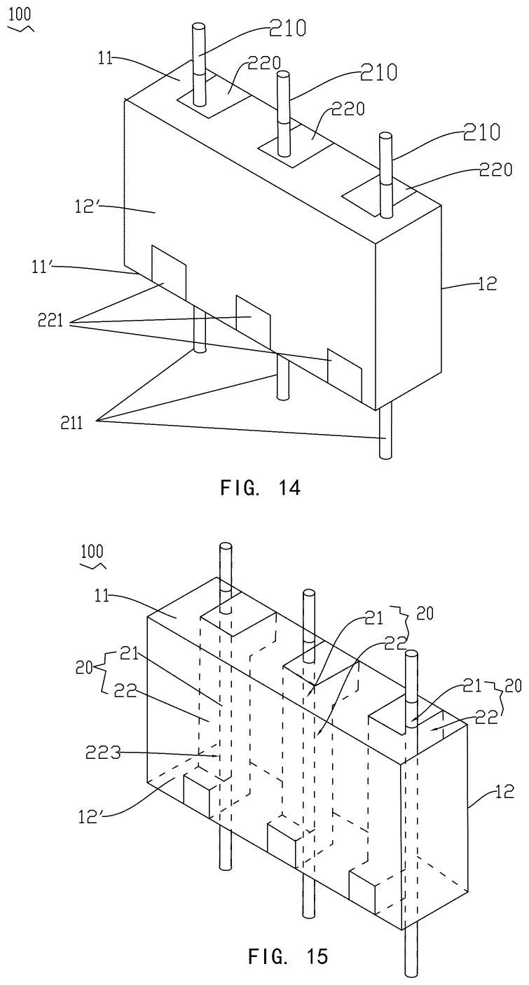

Referring to FIGS. 14-17, the integrated inductor 100 in accordance with a fifth embodiment includes the square (not limited to square) magnetic core 10 and multiple conductive coil assemblies 20 embedded in the magnetic core 10 to form a multi-phase coupling integration. As shown in the figures, three conductive coil assemblies 20 are arranged in parallel and spaced apart in the magnetic core 10, and the inner and outer conductive coils 21 and 22 are parallel to each other. Each conductive coil assembly 20 includes a pair of inner and outer conductive coils 21 and 22. The outer conductive coil 22 having a main body and opposite leads 220 and 221, is Z-shaped as a whole. The main body of the outer conductive coil 22 is linear or straight. The two adjacent outer conductive coils 22 at one outermost side and the middle position, respectively form a straight channel 223 inside along a length direction thereof, while the conductive coil 22 on the other outmost side forms an open straight groove 224 on its surface away from the other two outer conductive coils 22. The straight channel 223 and the open straight groove 224 extend to opposite end surfaces 11, 11′ of the magnetic core 10. The lead 220 of each outer conductive coil 22 is bent from one side of the main body and extends to the two adjacent end surfaces 11 and 12 of the magnetic core, and the other lead 221 is bent from the opposite side of the main body and extends to the two adjacent end surfaces 11′ and 12′ of the magnetic core. The end surfaces 11 and 11′ are opposite to each other. The end surfaces 12 and 12′ are opposite to each other. The leads 220 and 221 are embedded in the end surfaces, exposed on the end surface and keep the end surfaces flat or planar. The leads 220 and 221 may be electrically connected and covered respectively by a conductive coating on the end surfaces of the magnetic core for facilitating electrical connection with the circuit board. The inner conductive coil 21 is a straight-out conductive coil, and is inserted parallelly along the length direction into the straight channel 223 formed in the outer conductive coil or inserted into the open straight groove 224 formed on the surface of the outer conductive coil. The leads 211, 210 respectively extend outwards from the leads 220, 221 of the conductive coil 22 and extend outwards from opposite end surfaces 11, 11′ of the magnetic core 10. The straight inner conductive coil 21 is inserted into the straight channel 223 or the straight groove 224. The gap between the inner conductive coil and the inner wall of the straight channel 223/straight groove 224 is filled with insulating magnetic powder to form a thin insulating layer. The magnetic powder and the conductive coils 21 and 22 are integrated together by means of the integrated molding process. The insulating magnetic powder material is evenly distributed between the conductive coils, so that the conductive coils 21 and 22 are spaced at the closest distance and electrically insulated from each other. There is almost no air gap inside the magnetic core 10. The inner and outer conductive coils 21 and 22 is fully coupled, and the coupling coefficient exceeds 0.98. Alternatively, the surface of the inner conductive coil 21 is covered with a thin insulating layer, is inserted into the straight channel 223/open straight groove 224 and is electrically insulated from the outer conductive coil 22.

This embodiment takes three-phase coupling as an example to illustrate the principle of multi-phase coupling. The first, second, and third (or more) inner conductive coils are electrically connected in series, and the first outer conductive coil is coupled to the first inner conductive coil, the coupling signal (current and voltage) formed in the first inner conductive coil must flow through the second and third inner conductive coils. Moreover, the second inner and outer conductive coils are fully coupled to each other, and the third inner and outer conductive coils are fully coupled, thus a high response is obtained.

The integrated inductor 100 of the present invention is used as an inductor for a trans-inductor voltage regulator (TLVR). The TLVR comprise a circuit board, and the inductor 100 is electrically connected with a circuit in the circuit board.

In the integrated inductor 100 of the present invention, one or more conductive coil assemblies 20 are embedded in the magnetic core 10. The integrated inductor 100 can be single-phase coupling or multi-phase coupling. The straight-out inner conductive coil 21 is built-in the outer conductive coil 22 along a length direction thereof. When it is multi-phase coupled inductor, the outermost inner conductive coil 21 is embedded in an open groove 224 on the surface of the corresponding outer conductive coil 22. A spacing between the inner conductive coil 21 and the outer conductive coil 22 of each conductive coil assembly 20 is close enough so as to obtain a very high coupling, such as the coupling coefficient can be 0.98 or above, and the inductor 100 is nearly an omnicoupled (full coupling) inductor, and has a fast response. Through high-pressure molding of soft magnetic powder (particles) and conductive coils in one mold, the insulating magnetic powder (particle) material is evenly distributed between the conductive coils, thereby, the inner conductive coil 21 and the outer conductive coil 22 are spaced at the closest distance and are insulated from each other. There is almost no air gap inside the entire inductor 100 (or magnetic core 10) to obtain full space utilization and high-power density. The magnet core 10 and conductive coils 21, 22 are fully contacted and closely combined to realize rapid heat transfer and good heat dissipation effect, which keeps the inductor at a lower operating temperature. The inductor 100 of the present invention is simpler for manufacturing and applicable for SMD packaging, therefore, it is easy to realize an automagical manufacturing process, and the manufacturing method for the inductor and the inductor are low-cost. The integrated inductor of the present invention can be integrated with single or multiple phases to obtain a small size with high power density. The inductor in accordance with some embodiments of the present invention is formed by integrating the magnetic core made of soft magnetic powder (particles) and conductive coils in one mold, the entire closed magnetic path of the inductor is provided by the magnetic materials, and there is no obvious air gap in the inductor or in the magnetic core; therefore, the integrated inductor provided by the present invention obtains magnetic shield, which represents an anti-electromagnetic interference function.

The technical features of the above embodiments can be combined arbitrarily. In order to make the description simple, all possible combinations of the technical features in the above embodiments are not described. However, as long as there is no contradiction in the combination of these technical features It is considered to be the range described in this specification.

The above examples only represent several embodiments of the present invention, and the descriptions thereof are specific and detailed, but should not be construed as a limitation on the scope of the invention patent. It should be pointed out that for those of ordinary skill in the art, without departing from the concept of the present invention, several modifications and improvements can also be made, which all belong to the protection scope of the present invention. Therefore, the protection scope of the patent of the present invention should be subject to the appended claims.

What is claimed is:

1. An inductor, comprising:
a magnetic core; and
one or more conductive coil assembly embedded in the magnetic core, each conductive coil assembly comprising:
an inner conductive coil; and
an outer conductive coil coupled to the inner conductive coil;
wherein the inner conductive coil and the outer conductive coil are insulated from each other; the inner conductive coil rans through the outer conductive coil whereby most of or all magnetic field lines of the inner conductive coil pass through the outer conductive coil.

2. The inductor as claimed in claim 1, wherein a straight channel is formed inside the outer conductive coil and extends to opposite sides of the outer conductive coil and extends to opposite end surfaces of the magnetic core; the outer conductive coil has a main body and opposite leads at opposite sides thereof, the opposite leads extend to said opposite end surfaces of the magnetic core respectively; the inner conductive coil is straight, has a main body and opposite leads at opposite ends thereof, and is inserted in the straight channel in the outer conductive coil, and the opposite leads of the inner conductive coil extend to and said opposite end surfaces of the magnetic core.

3. The inductor as claimed in claim 2, wherein the main body of the outer conductive coil is straight, the straight channel is provided in the straight main body along a length thereof; the inner conductive coil inserted in the straight channel of the outer conductive coil, has the opposite leads thereof passing through the opposite leads of the outer conductive coil and extending to opposite end surfaces of the magnetic core respectively; and the inner conductive coil is parallel to the straight main body of the outer conductive coil.

4. The inductor as claimed in claim 2, wherein the outer conductive coil is U-shaped or Z-shaped or straight as a whole.

5. The inductor as claimed in claim 4, wherein the opposite leads of the U-shaped outer conductive coil are bent respectively from opposite sides of the main body, extend to opposite end surfaces of the magnetic core, and are exposed on said opposite end surfaces and/or exposed on the same adjacent end surface of said opposite end surface of the magnetic core; and the end surfaces of the magnetic core with the leads thereon is kept flat or planar.

6. The inductor as claimed in claim 4, wherein the opposite leads of the Z-shaped outer conductive coil are bent respectively from opposite sides of the main body, extend to said opposite end surfaces of the magnetic core, and are exposed on said opposite end surfaces and/or exposed on respective adjacent surfaces of said opposite end surfaces of the magnetic core; and the end surfaces of the magnetic core with the leads thereon is kept flat or planar.

7. The inductor as claimed in claim 2, wherein the inner conductive coil is covered with an insulating layer and/or an inner wall of the straight channel is covered with an insulating layer; the inner conductive coil and the outer conductive coil are insulated from each other by the insulating layer, and the insulating layer provides a spacing between the inner conductive coil and the inner wall of the straight channel close enough whereby a coupling coefficient between the inner conductive coil and the outer conductive coil reaches 0.98 or above.

8. The inductor as claimed in claim 2, wherein insulating magnetic powder is filled between the inner conductive coil and an inner wall of the straight channel to form an insulating layer therebetween which provides electrical insulation and a sufficiently close distance between the inner conductive coil and the outer conductive coil, whereby a coupling coefficient between the inner conductive coil and the outer conductive coil reaches 0.98 or above.

9. The inductor as claimed in claim 2, wherein the inductor is an integrated inductor manufactured by an integrated molding process; the conductive coil assembly is inseparably embedded in the magnetic core.

10. The inductor as claimed in claim 9, wherein the magnetic core and the conductive coil assembly are integrated by means of the integrated molding process using magnetic powder filing around the conductive coil assembly in one mold, whereby the magnetic core and the conductive coils are fully contacted and tightly combined; the integrated molding process comprising steps of:
a pressing and molding step; and
an annealing step.

11. The inductor as claimed in claim 10, wherein:
the pressing and molding step is that: installing conductive coil assembly in a cavity of the mold with the inner conductive coil inserted into the outer conductive coil, filling the cavity of the mold with magnetic powder, applying pressure for molding, then obtaining a raw inductor of which the conductive coils are embedded in the magnetic core and the leads are exposed on the end surfaces of the magnetic core; and
the annealing step is that: placing the raw inductor in a heat treatment furnace for calcinating and annealing so as to release residual stress inside the magnetic core, and obtaining an integrated inductor.

12. The inductor as claimed in claim 11, wherein at the pressing and molding step, the pressure for molding is 12˜24 T/cm2; and at the annealing step, a temperature in the heat treatment furnace is 400˜850° C.

13. The inductor as claimed in claim 1, wherein the inductor is a multi-phase coupling inductor and comprises multiple conductive coil assemblies embedded in the magnetic core, and each conductive coil assembly includes the inner conductive coil and the outer conductive coil that are coupled to each other.

14. The inductor as claimed in claim 13, wherein each conductive coil assembly is arranged in parallel and spaced apart from each other, and the inner conductive coil and the outer conductive coil are parallel to each other; the inner conductive coils of each conductive coil assembly are electrically connected in series, and the outer conductive coils and corresponding inner conductive coils of each conductive coil assembly are coupled to each other, thereby a high dynamic response is obtained.

15. The inductor as claimed in claim 13, wherein for one multiple conductive coil assembly, which is located at one side of the magnetic core, the outer conductive coil defines an open straight groove along a length thereof, and the inner conductive coil is inserted in the open straight groove; the open straight groove extends to opposite sides of the outer conductive coil and extends to opposite end surfaces of the magnetic core.

16. The inductor as claimed in claim 15, wherein for other multiple conductive coil assemblies, the outer conductive coil defines a straight channel therein along a length thereof, the straight channel extends to opposite sides of the outer conductive coil and extends to said opposite end surfaces of the magnetic core; the outer conductive coil has a straight main body and opposite leads at opposite sides thereof, the opposite leads extend to said opposite end surfaces of the magnetic core respectively; the inner conductive coil is a straight, has a main body and opposite leads at opposite ends thereof, and is inserted in the straight channel in the outer conductive coil, and the opposite leads of the inner conductive coil pass through the opposite leads of the outer conductive coil and extend to said opposite end surfaces of the magnetic core, respectively.

17. A trans-inductor voltage regulator, comprising:
a circuit board; and
an inductor electrically connected to the circuit board, the inductor comprising:
a magnetic core; and
one or more conductive coil assembly embedded in the magnetic core, each conductive coil assembly comprising:
an inner conductive coil; and
an outer conductive coil coupled to the inner conductive coil;
wherein the inner conductive coil and the outer conductive coil are insulated from each other; the inner conductive coil rans through the outer conductive coil whereby most of or all magnetic field lines of the inner conductive coil pass through the outer conductive coil.

18. The trans-inductor voltage regulator as claimed in claim 17, wherein a straight channel is formed inside the outer conductive coil and extends to opposite sides of the outer conductive coil and extends to opposite end surfaces of the magnetic core; the outer conductive coil has a main body and opposite leads at opposite sides thereof, the opposite leads extend to said opposite end surfaces of the magnetic core respectively; the inner conductive coil is straight, has a main body and opposite leads at opposite ends thereof, and is inserted in the straight channel in the outer conductive coil, and the opposite leads of the inner conductive coil extend to and said opposite end surfaces of the magnetic core.

19. The trans-inductor voltage regulator as claimed in claim 18, wherein the outer conductive coil is U-shaped or Z-shaped or straight as a whole.

20. The trans-inductor voltage regulator as claimed in claim 18, wherein the inductor is a multi-phase coupling inductor and comprises multiple conductive coil assemblies embedded in the magnetic core, and each conductive coil assembly includes the inner conductive coil and the outer conductive coil that are coupled to each other.
